(19) United States
(12) Patent Application Publication
(10) Pub. No.: US 2007/0231228 A1
(43) Pub. Date: Oct. 4, 2007

(54) Low-insoluble sodium carbonate production

(75) Inventors: Allan L. Turner, Lakewood, CO (US); John Edward Litz, Lakewood, CO (US)

Correspondence Address: ALLAN L. TURNER, 1476 S. LEE COURT, LAKEWOOD, CO, 80232, US

(73) Assignee: Environmental Projects, Inc., Casper, WY (US)

(21) Appl. No.: 10/932,639

(22) Filed: Sep. 2, 2004

(51) Int. Cl. C01D 7/12

(52) U.S. Cl. 423/206.2

(57) ABSTRACT

A method of rejecting insoluble impurities during the production of sodium carbonate from trona ore comprising removal of minus 10 micrometer insoluble impurities from a calcined, crushed trona feed stream, slurried feed stream, and/or recrystallized slurried feed stream with the resulting sodium carbonate product containing less than about 0.2% insoluble impurities.

### REFERENCES CITED

| | | | |
|---|---|---|---|
| 1,650,244 | November 1927 | Sundstrom, et. al. | 23/63 |
| 1,907,987 | May 1933 | Lynn | 23/63 |
| 2,639,217 | May 1953 | Pike | 23/63 |
| 2.704,239 | March 1955 | Pike | 23/302 |
| 2,770,524 | November 1956 | Seaton, et. al. | 23/63 |
| 2.792,282 | May 1957 | Pike | 23/38 |
| 2,887,360 | May 1959 | Hoekje | 23/63 |
| 2,962,348 | November 1960 | Seglin, et. al. | 23/63 |
| 2,970,037 | January 1961 | Caldwell, et, al. | 23/63 |
| 3,233,983 | February 1966 | Bauer, et. al. | 23/300 |
| 3,236,590 | February 1966 | Sopchak, et. al. | 723/426 |
| 3,260,567 | July 1966 | Hellmers, et. al. | 23/63 |
| 3,264,057 | August 1966 | Miller | 23/63 |
| 3,273,958 | September 1966 | Peverley | 423/206 |
| 3,425,795 | February 1969 | Howard, et. al. | 23/63 |
| 3,455,647 | July 1969 | Gloster | 423/206 |
| 3,479,133 | November 1969 | Warzel | 23/63 |
| 3,498,744 | March 1970 | Frint, et. al. | 23/63 |
| 3,528,766 | September 1970 | Coglaiti | 23/63 |
| 3,655,331 | April 1972 | Seglin, et. al. | 23/63 |
| 3,717,698 | February 1973 | Ilardi, et. al. | 423, 206 |
| 3,836,628 | September 1974 | Ilardi, et. al. | 423/206 |
| 3,904,733 | October 1975 | Gancy, et. al. | 423/206 |
| 3,933,977 | January 1976 | Ilardi, et. al. | 423/206 |
| 3,956,457 | May 1976 | Port, et. al. | 423/206 |
| 3,981,686 | September 1976 | Lobunez, et. al. | 423/421 |
| 4,021,527 | May 1977 | Baadsgaard | 423/206 |
| 4,286,967 | September 1981 | Booth, et. al. | 23/302 |
| 4,299,799 | November 1981 | Ilardi, et. al. | 423/206 |
| 4,557,910 | December 1985 | Meadow | 423/206 |
| 4,814,151 | March 1989 | Benke | 423/206 |
| 5,618,504 | April 1997 | Delling, et. al. | 23/302 |
| 5,624,647 | April 1997 | Zolotoochin, et. al. | 423/206 |
| 6,010,672 | January 2000 | Turner | 423/206 |
| 6,284,005 | September 2001 | Hazen, et. al. | 23/302 |

### I. FIELD OF THE INVENTION

The invention relates to the production of a low-insoluble sodium carbonate product from trona or nahcolite ore.

### II. BACKGROUND OF THE INVENTION

There have been a great number of prior art processes related to the production of sodium carbonate (soda ash) from trona or nahcolite ores. In essentially all of these, the probability of contamination of the final product by insoluble material is tacitly recognized and steps are taken to prevent the crystallization of the precursors of the final product from taking place in the presence of the insoluble material. In the others, the contamination of the product by insoluble matter is acknowledged.

Many early patents describe the crystallization of sodium sesquicarbonate from an insoluble-free solution—such solution being obtained by calcining trona, dissolving the alkali values from the calcine, and separating the insolubles from the solution. The methods of separation are described variously as “remove” (See U.S. Pat. Nos. 2,639,217, 2,704,239, 2,792,282, 3,028,215, 3,479,133), “clarify and filter” (See U.S. Pat. Nos. 2,962,348, 2,970,037, 3,273,958), “separate and filter” (See U.S. Pat. No. 3,260,567), “separate” See U.S. Pat. No. 3,425,795), or “filter” (See U.S. Pat. Nos. 2,770,524, 3,455,647).

Later patents describe the crystallization of sodium carbonate monohydrate from trona-derived solutions that also utilize insoluble removal prior to the crystallization. In these instances, the terms used when describing insoluble removal include “clarification” (See U.S. Pat. Nos. 3,498,744, 3,717,698, 4,021,527, 4,299,799), “separate” (See U.S. Pat. Nos. 3,655,331, 3,836,628, 3,904,733), “remove” (See U.S. Pat. Nos. 3,981,686, 5,624647), “filter” (See U.S. Pat. No. or “clarify and filter” (See U.S. Pat. Nos. 3,528,766, 3,933,977, 3,956,457, 4,814,151). U.S. Pat. No. 4,557,910 describes the production of sodium carbonate monohydrate from an insoluble-free, nahcolite derived solution. Another patent (U.S. Pat. No. 3,264,057) describes a process whereby insoluble material is “separated” from a solution derived from leaching trona prior to steam stripping to recover the alkali product.

Other patents describe the production of other forms of alkali from trona and also utilize removal of the insoluble material prior to the crystallization of the products. For instance, the final products described in U.S. Pat. No. 5,624,647 are sodium carbonate decahydrate and sodium bicarbonate. This patent carefully specifies that “removal of insolubles” should precede the crystallization of the products. U.S. Pat. No. 5,618,504 teaches the separation and removal of the insoluble material prior to bicarb production.

There are several patents that describe the production of sodium carbonate monohydrate, sodium carbonate decahydrate, and/or sodium bicarbonate from solutions obtained by the in situ leaching of trona or nahcolite deposits. These solutions typically contain little or no insoluble material and, therefore, products crystallized from these solutions have no appreciable quantities of insolubles. The teachings of these patents are, therefore, not applicable to the teachings of the present patent.

Two patents describe the contamination of the alkali products with insolubles when sodium carbonate monohydrate is crystallized in the presence of insolubles.

Howard in U.S. Pat. No. 3,425,795 teaches that a dense soda ash (sodium carbonate) can be produced containing less than 1%, and generally less than 0.5% water-insoluble impurities by: 1) calcining trona ore, 2) reducing the calcine to preferably less than 100 mesh, 3) adding the crushed calcine trona to an aqueous stream saturated with sodium carbonate to form sodium carbonate monohydrate crystals greater than 100 mesh, 4) separating the sodium carbonate monohydrate crystals from the minus 100 mesh insoluble particles, 5) converting the sodium carbonate monohydrate to anhydrous sodium carbonate in the presence of higher temperature, higher pressure, and potassium carbonate, 6) separating the anhydrous sodium carbonate from the solution, 7) sending the solution to insoluble removal, and 8) recycling the cleaned solution to step 3). Even though a recrystallization step is included to reach the final anhydrous product, Howard indicates that the product will still be contaminated with as much as 1% insoluble although he hopes for somewhat less than 0.5%. There is no indication in this patent of the insoluble content of the intermediate sodium carbonate monohydrate.

Frint in U.S. Pat. No. 3,498,744 describes the production of sodium carbonate monohydrate in the presence of insoluble matter by: 1) calcining trona, 2) pulverizing the calcined trona to less than 100 mesh, 3) adding hot, pulverized trona to a hot solution saturated with sodium carbonate to produce sodium carbonate monohydrate crystals greater than 100 mesh, 4) separating the large sodium carbonate monohydrate crystals from the minus 100 mesh insoluble particles, 5) separating the insoluble particles from the solution, and 6) recycling the clean solution back to step 3). Frint states: “Since some of the insoluble impurities will be included with the monohydrate crystals, it is difficult to get a C.P. grade soda ash product, but the soda ash will be or a consistent high quality suitable for industrial use.” He also states that, with the inclusion of the insoluble separation step, the purity of the product will ordinarily vary from 98.9% to 99.5%.

All of the present commercial sodium carbonate production from trona ore or nahcolite ore utilizes an insolubles removal step prior the crystallization of the product. Therefore, prior to the present invention, through published information and by practice, it was accepted that if alkali products were crystallized from a medium, which included insoluble materials, the product would contain excessive insoluble material. However, through the present invention, it has been found that, in fact, alkali products (e.g. dense soda ash) that have been crystallized in the presence of insoluble materials can have an acceptable insoluble content.

Sodium carbonate monohydrate crystallization processes referred to in the present patent are not a part of the claims of the present patent. Some of the crystallization processes that could be employed during the use of the present patent are described in U.S. Pat. Nos. 2,887,360, 3,236,590, 3,425,795, 3,498,744, 6,010,672, and 6,284,005.

### III. SUMMARY OF THE INVENTION

The present invention describes a method for the production of a soda ash product, with a low insoluble content, from trona or nahcolite ores. It has been found that the size of insoluble particles within the precursor sodium carbonate monohydrate (monohydrate) crystals is less than 10 micrometers in diameter. Therefore, by substantially excluding this size fraction from the monohydrate crystallization step insures that the final soda ash product will have an insoluble content of less than 0.2%, by weight. The trona or nahcolite ore is crushed to less than 80 mesh. The fraction of this crushed ore that is less than 10 micrometers will vary with the type of ore and crushing method. The material that is less than 10 micrometer may be removed prior to slurrying with saturated sodium carbonate solution, or may be removed after the slurrying, or may be removed following monohydrate recrystallization (s). After the substantial removal of the particles of less than 10 micrometers, there must be one additional monohydrate crystallization in order to achieve a final soda ash product with an insoluble content of less than 0.2%.

### IV. BRIEF DESCRIPTION OF THE DRAWINGS

FIG. 1 “Low-Insoluble Sodium Carbonate Production” This figure is a schematic flow sheet showing steps of insoluble material removal.

FIG. 2 “Photomicrograph Showing Insoluble Particles within Crystallized Sodium Carbonate Monohydrate” This photomicrograph of the interior of a sodium carbonate monohydrate crystal shows that the majority of the entrained insoluble particles are less than about six micrometers in diameter and that essentially all of the entrained insoluble particles are less than about ten micrometers in diameter.

FIG. 3 “Photomicrograph Showing Insoluble Particles within Recrystallized Sodium Carbonate Monohydrate” This photomicrograph of the interior of a recrystallized sodium carbonate monohydrate crystal shows much fewer insoluble particles than in FIG. 2. The insoluble particles are still less than about ten micrometers in diameter with essentially all less than about six micrometers.

### V. DETAILED DESCRIPTION OF THE INVENTION AND THE PREFERRED EMBODIMENT

The present invention is described herein as it relates to the discovery that insoluble particles less than ten micrometers can be contained within the crystal lattice of sodium carbonate monohydrate crystals, and as it relates to the method of prevention and removal of these insoluble impurities. While the present invention is based on the production of sodium carbonate monohydrate and subsequent drying to sodium carbonate (soda ash) from the trona deposits of Wyoming, it is reasonable to believe that the phenomenon discovered and the methods of remediation would be experienced during sodium carbonate monohydrate crystallizations from other trona and nahcolite deposits around the world.

In the present production methods and in the majority of the patent literature, the production of sodium carbonate monohydrate crystals is carried out in a substantially insoluble-free environment. This involves calcining trona, nahcolite, or sodium sesquicarbonate to sodium carbonate; dissolving the sodium carbonate in an aqueous solution; separating the sodium carbonate-containing solution from any insoluble material present via filtration or similar processes; evaporating the clean solution to produce sodium carbonate monohydrate substantially free of insoluble impurities; and drying the sodium carbonate monohydrate to sodium carbonate.

However, there may be an economic advantage to be able to carry out the crystallization of sodium carbonate monohydrate in an insoluble-containing environment. Such a process would involve calcining trona, nahcolite, or sodium sesquicarbonate to sodium carbonate; converting the sodium carbonate to sodium carbonate monohydrate in an aqueous medium; separating the sodium carbonate monohydrate from the insolubles; and drying the sodium carbonate monohydrate to sodium carbonate. It is obvious that the deletion of the evaporation step would be economically desirable.

We have found, however, that the crystallization of the sodium carbonate monohydrate in an aqueous medium containing insoluble particles of less than about ten micrometers (−10 μm) in size can result in the inclusion of these insoluble particles in the monohydrate crystals. The extent of this contamination will normally exceed the about 0.2% considered excessive for the present dense soda ash produced in Wyoming.

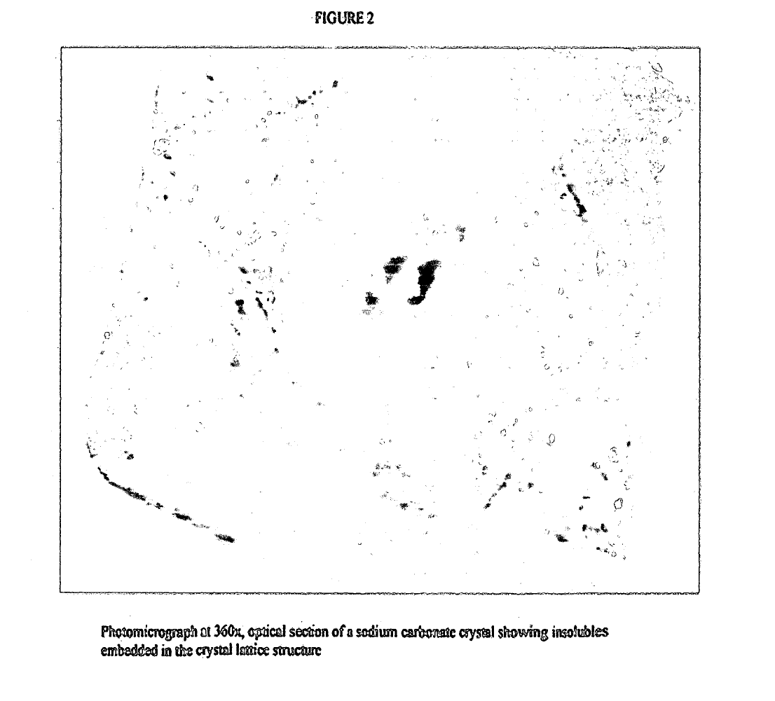

FIG. 2, “Photomicrograph Showing Insoluble Particles within Crystallized Sodium Carbonate Monohydrate”, shows an optical section of a crystal of sodium carbonate monohydrate that had been crystallized in an aqueous solution in the presence of insolubles contained in calcined and crushed Wyoming trona ore. Insolubles can be seen embedded in the crystal lattice structure. It can also be seen that in all cases, the particle sizes of the insolubles are less than about ten micrometers in diameter and most are less than about six micrometers in diameter. The insolubles within the crystallization media had a size analysis as shown in Table I. It can, therefore, be concluded that since the greater weight percentage of insolubles were in a size range greater than ten micrometers, the crystal lattice preferentially includes insoluble material having a size of less than about ten micrometers and more preferably less than about six micrometers. Likewise, insoluble particles having a size greater than about ten micrometers are preferentially excluded.

TABLE I
INSOLUBLE PARTICLE SIZE ANALYSIS

| Micrometers | Weight Percent |
|---|---|
| −5 | 14.35 |
| +5-10 | 12.60 |
| +10-50 | 64.64 |
| +50-100 | 7.55 |
| +100 | 0 86 |

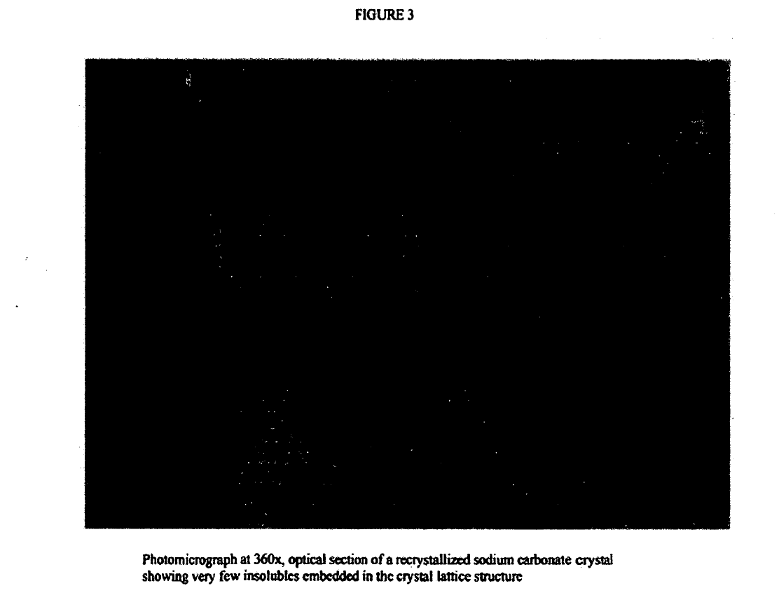

FIG. 3, “Photomicrograph Showing Insoluble Particles within Recrystallized Sodium Carbonate Monohydrate”, shows an optical section of a crystal of sodium carbonate monohydrate that had been recrystallized in an aqueous solution in the presence of only those insolubles contained within the feed sodium carbonate monohydrate. A few insolubles can be seen embedded in the crystal lattice structure. It can also be seen that in all cases, the particle sizes of the insolubles are still less than about ten micrometers in diameter and most are less than about six micrometers in diameter. The insolubles within the crystallization medium were all less than 10 micrometers in diameter and the great majority were less than 6 micrometers in diameter. The crystal shown in FIG. 3 is, in fact, recrystallized from crystals similar to the one shown in FIG. 2. With the recrystallization, the weight of insolubles within the crystals was reduced by over 90%. The reason for the reduction was that both the weight and quantity of insolubles during the recrystallization was considerably less than during the initial crystal formation since the only source of insolubles during the recrystallization was those contained within the feed crystals.

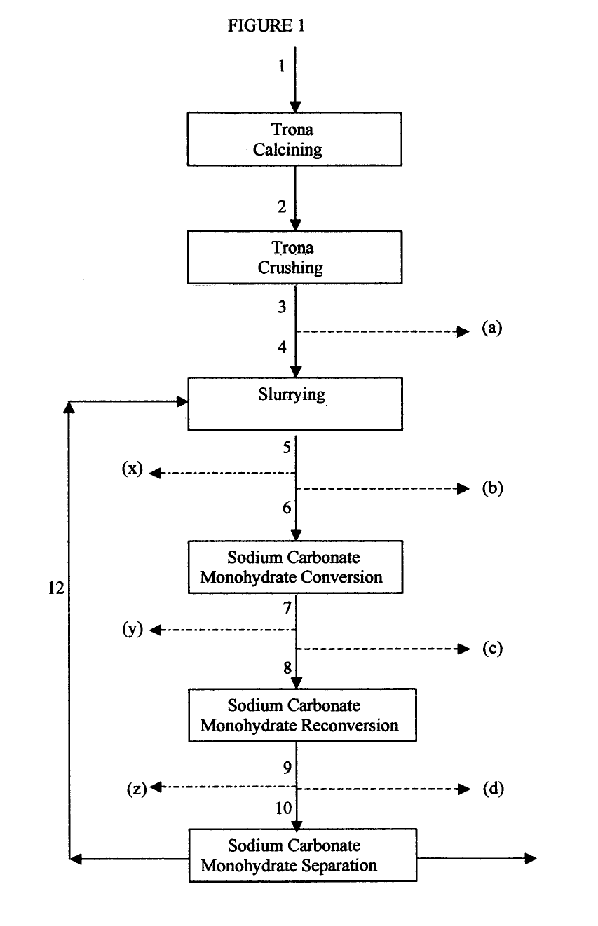

This discovery suggests that a schematic flow sheet such as that shown as FIG. 1 can be utilized to produce a sodium carbonate monohydrate product with a low insoluble content even though it is crystallized in the presence of insoluble material. Likewise, the dense soda ash resulting from the dehydrating of this sodium carbonate monohydrate will have a low insoluble content. It will be noted when reading the description of FIG. 1, that in order to attain a low-insoluble product, at least one conversion (recrystallization) of sodium carbonate monohydrate through the anhydrous phase and back to the monohydrate phase must be experienced in a medium with a low content of less-than 10 micrometer particles.

As shown in FIG. 1, trona or nahcolite ore (1) is calcined under the appropriate conditions to convert the alkali content of the ore to anhydrous sodium carbonate. The calcined ore (2) is then crushed to at least less than 80 mesh and preferably less than 100 mesh. The crushing of the ore may be accomplished prior to the calcining step. Alternately, the ore may be partially crushed prior to calcining and then subjected to a final crushing following the calcining step.

The term “crushing” is usually used to describe a size reduction to a particle size of greater than 80 mesh and the term “milling” is usually used to describe the production of particles of less than 80 mesh; however, in this case, the equipment utilized to accomplish the size reduction is more associated with a “crushing” operation and, therefore, the term “crushing” is used. In order to produce a minimum of particles less than ten micrometers, it is appropriate that equipment such as roll crushers, single cage mills, or double cage mills be utilized. If equipment such as attrition or rod mills are utilized, the production of particles less than 6 to 10 micrometers is excessive and the subsequent removal of the particles of less than 6 to 10 micrometers can result in an excessive loss of the alkali material.

Following size reduction, the material less than 6 to 10 micrometers may be removed (a) from the crushed, calcined ore (3) by screening, cycloning, classification, or other appropriate means. At this point the material less than 6 to 10 micrometers will contain sodium carbonate values in addition to insoluble values. The sodium carbonate values may be dissolved leaving the insoluble solids, which may be filtered or otherwise removed. The resulting sodium carbonate solution may be utilized elsewhere in the process. However, if the sodium carbonate contained in the less than 6 to 10 micrometer fraction (a) is too great to be fully utilized elsewhere in the process, the removal of the less than 6 to 10 micrometer fraction may be accomplished at a later point in the process.

The less than 80 mesh and preferably less than 100 mesh calcined trona with or without removal of the less than the 6 to 10 micrometer fraction (4) is slurried with a saturated sodium carbonate solution (12). If the conditions of this slurrying step are carried out as described in U.S. Pat. Nos. 3,425,795, 3,498,744, and/or 6,284,005, there is a probability that many sodium carbonate monohydrate crystals greater than about 80 mesh will be crystallized. However, the processes described in these patents are noted for being inefficient in producing 100% of the alkali as crystals of greater than 80 mesh due to the inability to control the exact temperatures required, the inability to control the agitation required, or the inability to control other conditions. Therefore, the separation of insoluble material of less than about 80 mesh will usually also include the separation of small crystals of sodium carbonate monohydrate, resulting in a lower alkali recovery.

Certainly, there is a much great probability that essentially all of the sodium carbonate monohydrate crystals from the slurrying will have a size greater than about 6-10 micrometers by following the teaching of U.S. Pat. Nos. 3,425,795, 3,498,744, and 6,284,005. This means that any insoluble particles less than 10 micrometer can be removed without substantially diminishing the recovery of an alkali product. By substantially removing the insoluble particles less than about 6 to 10 micrometers (b) from slurry (5), sodium carbonate monohydrate crystals resulting from subsequent conversions or recrystallizations will have a high probability of being able to meet the insoluble specification of the final soda ash product.

It may be appropriate for a practitioner of this present patent to simply add the calcined, crushed trona to the slurrying step without attempting to grow large crystals of the sodium carbonate monohydrate. In this case, the sodium carbonate monohydrate crystals will have a wide size range.

There is a high probability that the sodium carbonate monohydrate crystals produced in the slurrying step will contain 0.5 to 1.5%, by weight, insoluble material, consisting of insoluble particles of less than 6 to 10 micrometers in diameter contained within the monohydrate crystals. In addition, there will be a high probability that there will be fine sodium carbonate monohydrate crystals present. This may indicate to practitioners of this present patent to delay the removal of less than 80 mesh insoluble particles until after a conversion step where the great majority of the sodium carbonate monohydrate will be greater than 80 mesh.

Sodium carbonate monohydrate conversion or recrystallization may be accomplished by the use of the teachings such as in U.S. Pat. Nos. 2,887,360, 3,236,590, 3,425,795, and 6,284,005. The sodium carbonate monohydrate slurry stream (7) resulting from the conversion will contain the less than 80 mesh insolubles if they were not removed before the conversion step. The slurry will contain as individual particles: (A) all of the less-than 10 micrometer insolubles minus those within the sodium carbonate monohydrate crystals if no less-than 10 micrometer insoluble particles were removed prior to the conversion step; or (B) the majority of the less-than 10 micrometer insolubles included within the crystals feeding the conversion step if the less-than 10 micrometer insoluble particles were removed (b) from the slurry feeding the conversion step (6).

As described in the patents listed in the previous paragraph, the great majority of the sodium carbonate monohydrate crystals in slurry (7) from the conversion step will be greater than 80 mesh in size. A separation of the crystals from the less-than 80 mesh insoluble material can be accomplished comparatively efficiently by screening, cycloning, air classification, mechanical classification or other means. Essentially all of the less-than 10 micrometer insoluble particles not entrained within the sodium carbonate monohydrate crystals will be removed with the insoluble stream (c).

If there was a removal of the less-than 10 micrometer insoluble particles prior to the conversion step such as at (b), the sodium carbonate monohydrate crystals in stream (8) will have an insoluble content of less than about 0.2% on an anhydrous sodium carbonate basis. However, if the less-than 10 micrometer insolubles were not removed prior to the conversion step, an additional conversion step will be required to achieve a product with an acceptable insoluble content. In this case, slurry (8) with essentially no free insoluble particles is subjected to a reconversion via one of the methods described in the cited patents.

This reconversion will free the insolubles within the crystals in stream (8) to produce a slurry (9) consisting of essentially insoluble-free sodium carbonate monohydrate crystals plus the insoluble particles released from the crystals during the reconversion. At this point, the less-than 6 to 10 micrometers insolubles may be removed via cyclone separation, elutriation, settling/thickening, and/or screening as steam (d). Separation of the sodium carbonate monohydrate crystals, represented by stream (11), may be made with the crystals sent to product preparation and the solution being recycled to the initial slurrying step. This solution may be subjected to a polish filtration to insure that no less-than 6 to 10 insoluble material is recycled.

The separation of the less-than 10 micrometer material may be made more than once during the process to produce a low-insoluble product. For instance, a classification may be made at point (a) and point (b), or (a) and (c), or (b) and (c). By removing the less-than 10 micrometer material at two points, a product with even lower insoluble content will be obtained.

### EXAMPLE 1

Trona ore obtained from the trona deposit in Wyoming was calcined and crushed to less than 100 mesh. This calcined trona was added to a recycle solution saturated with sodium carbonate and containing insoluble particles to form a slurry of 20% sodium carbonate monohydrate and 3.3% insoluble particles. The temperature of this slurry was then raised to above the transition temperature for the formation of anhydrous sodium carbonate. A subsequent lowering of the temperature caused sodium carbonate monohydrate to again crystallize. The following table shows the constituents of this mixture.

| Size (Micrometers) | Insoluble Material Wt. % | Monohydrate Wt % |
|---|---|---|
| 0.4-0.6 | 0.033 | |
| 0.6-1.0 | 0.107 | |
| 1.0-10 | 0.849 | |
| 10-149 | 2.311 | 0.04 |
| 149-210 | | 4.10 |
| 210-297 | | 7.40 |
| 297-590 | | 8.46 |

When the quantities of particles are calculated based on 0.1 micrometer increments, it was found that the ratio of the insoluble particles to monohydrate crystals was 400,000-500,000 to 1 in the final slurry. The sodium carbonate monohydrate listed in the table contained 1.6% of entrained insoluble matter on an anhydrous basis. FIG. 2 is a photomicrograph of a cross-section of a crystal selected from this monohydrate. As discussed previously, the insoluble particles within the crystal are less than about 10 micrometers in diameter with most of the insoluble particles being less than about 6 micrometers in diameter.

### EXAMPLE 2

Sodium carbonate monohydrate product as described in Example 1 was slurried with saturated sodium carbonate solution devoid of insoluble matter. The temperature of this slurry was then raised to above the transition temperature for the formation of anhydrous sodium carbonate. A subsequent lowering of the temperature caused sodium carbonate monohydrate to again crystallize. Sodium carbonate monohydrate crystals with essentially the same size analysis listed in Example 1 were obtained. The insoluble analysis, however, was 0.16%, which is within the specifications of the normal commercial grade of soda ash produced in Wyoming. The reduced insoluble content of the sodium carbonate monohydrate crystals may be seen in FIG. 3.

We claim:

1. A process for the production of sodium carbonate monohydrate from trona ore, wherein the trona ore comprises trona and insoluble impurities, the process comprising:
(a) calcining the trona ore to produce a feed stream comprising anhydrous sodium carbonate and insoluble impurities;
(b) removing a size fraction comprising a less-than 10 micrometers size fraction from the feed stream to produce a modified feed stream;
(c) introducing the modified feed stream into a saturated sodium carbonate brine solution to form sodium carbonate monohydrate crystals; and
(d) separating at least a portion of the sodium carbonate monohydrate crystals from at least a portion of the insoluble impurities in the saturated sodium carbonate brine solution.

2. The process, as claimed in claim 1, further comprising crushing the trona ore to minus 80 mesh prior to the calcination step.

3. The process, as claimed in claim 1, further comprising crushing the feed stream to minus 100 mesh prior to the step of removal of a size fraction.

4. The process, as claimed in claim 1, wherein the size fraction is a less-than 10 micrometers size fraction.

5. The process, as claimed in claim 1, wherein the step of removing is selected from the group consisting of screening, cycloning, air classification, or mechanical classification,

6. The process, as claimed in claim 1, wherein the step of removing removes at least about 90% by weight of the minus 10 micrometers insoluble impurities to produce the modified feed stream.

7. The process, as claimed in claim 1, wherein the step of separating sodium carbonate monohydrate crystals from insoluble impurities is by size separation.

8. The process, as claimed in claim 7, wherein sodium carbonate monohydrate crystals separated from the insoluble impurities have a particle size of at least about 100 mesh.

9. The process, as claimed in claim 7, wherein a non-recovered portion from the step of size separating comprises insoluble impurities and sodium carbonate monohydrate crystals having a particle size of less than about 100 mesh.

10. The process, as claimed in claim 9, further comprising the step of dissolving sodium carbonate monohydrate crystals from the non-recovered portion and separating the insoluble impurities from the dissolved crystals.

11. The process, as claimed in claim 10, further comprising the step of recycling the dissolved sodium carbonate monohydrate crystals from the non-recovered portion by introducing a stream containing the dissolved sodium carbonate monohydrate crystals into the saturated sodium carbonate brine solution.

12. The process, as claimed in claim 1, further comprising the step of calcining the separated sodium carbonate monohydrate crystals to anhydrous sodium carbonate crystals.

13. The process, as claimed in claim 1, wherein the amount of insoluble impurities in the separated sodium carbonate monohydrate crystals is less than about 0.2% by weight.

14. A process for the production of sodium carbonate monohydrate from trona ore, wherein the trona ore comprises trona and insoluble impurities, the process comprising:
(a) Calcining the trona ore to produce a feed stream comprising anhydrous sodium carbonate and insoluble impurities;
(b) introducing the feed stream into a saturated sodium carbonate brine solution to form sodium carbonate monohydrate crystals;
(c) classifying particles in the saturated sodium carbonate brine solution to remove insoluble impurities;
(d) converting the sodium carbonate monohydrate crystals in the slurry to anhydrous sodium carbonate crystals and then back to sodium carbonate monohydrate crystals, and
(e) separating at least a portion of the sodium carbonate monohydrate crystals from at least a portion of the insoluble impurities in the saturated sodium carbonate brine solution.

15. The process, as claimed in claim 14, wherein the feed stream is crushed to minus 100 mesh.

16. The process, as claimed in claim 14, wherein the step of classifying removes at least about 90% by weight of the less-than 10 micrometers insoluble impurities introduced into the brine solution by the feed stream.

17. The process, as claimed in claim 14, wherein the step of classifying is selected from the group consisting of cyclone separation, elutriation, settling/thickening, and screening.

18. The process, as claimed in claim 14, wherein the step of classifying removes particles having a size less than about 10 micrometers.

19. The process, as claimed in claim 14, wherein the step of converting comprises raising the temperature of the saturated sodium carbonate brine comprising the modified feed stream to above about 112° C. to convert sodium carbonate monohydrate crystals into anhydrous sodium carbonate crystals; and lowering the temperature of the saturated sodium carbonate brine to below about 112° C. to convert anhydrous sodium carbonate crystals into a second sodium carbonate monohydrate slurry.

20. The process, as claimed in claim 14, wherein the step of separating sodium carbonate monohydrate crystals from insoluble impurities is by size separation.

21. The process, as claimed in claim 20, wherein the sodium carbonate monohydrate crystals separated from the insoluble impurities have a particle size of at least about 100 mesh.

22. The process, as claimed in claim 20, wherein a non-recovered portion from the step of size separating comprises insoluble impurities and sodium carbonate monohydrate crystals having a particle size of less than about 100 mesh.

23. The process, as claimed in claim 22, further comprising the step of dissolving sodium carbonate monohydrate crystals from the non-recovered portion and separating insoluble impurities from the dissolved crystals.

24. The process, as claimed in claim 23, further comprising the step of recycling the dissolved sodium carbonate monohydrate crystals from the non-recovered portion by introducing a stream containing the dissolved sodium carbonate monohydrate crystals into the saturated sodium carbonate brine solution.

25. The process, as claimed in claim 14, further comprising the step of calcining the separated sodium carbonate monohydrate crystals to anhydrous sodium carbonate crystals.

26. The process, as claimed in claim 14, wherein the amount of insoluble impurities in the separated sodium carbonate monohydrate crystals is less than about 0.2% by weight.

27. A process for the production of sodium carbonate monohydrate from trona ore, wherein the trona ore comprises trona and insoluble impurities, the process comprising:
(a) Calcining the trona ore to produce a feed stream comprising anhydrous sodium carbonate and insoluble impurities;
(b) introducing the feed stream into a saturated sodium carbonate brine solution to form sodium carbonate monohydrate crystals;
(c) converting the sodium carbonate monohydrate crystals in the slurry to anhydrous sodium carbonate crystals and then back to sodium carbonate monohydrate crystals, and
(d) classifying particles in the saturated sodium carbonate brine solution to remove insoluble impurities;
(e) reconverting the sodium carbonate monohydrate crystals in the slurry to anhydrous sodium carbonate crystals and then back to sodium carbonate monohydrate crystals, and
(f) separating at least a portion of the sodium carbonate monohydrate crystals from at least a portion of the insoluble impurities in the saturated sodium carbonate brine solution.

28. The process, as claimed in claim 27, wherein the feed stream is crushed to minus 100 mesh.

29. The process, as claimed in claim 27, where in the step of converting comprises raising the temperature of the saturated sodium carbonate brine comprising the modified feed stream to above about 112° C. to convert sodium carbonate monohydrate crystals into anhydrous sodium carbonate crystals; and lowering the temperature of the saturated sodium carbonate brine to below about 112° C. to convert anhydrous sodium carbonate crystals into a second sodium carbonate monohydrate slurry.

30. The process, as claimed in claim 27, wherein the step of classifying removes at least about 90% by weight of the less-than 10 micrometers insoluble impurities introduced into the brine solution by the feed stream.

31. The process, as claimed in claim 27, wherein the step of classifying is selected from the group consisting of cyclone separation, elutriation, settling/thickening, and screening.

32. The process, as claimed in claim 27, wherein the step of classifying removes particles having a size less than about 10 micrometers.

33. The process, as claimed in claim 27, where in the step of reconverting comprises raising the temperature of the second sodium carbonate monohydrate slurry to above about 112° C. to convert sodium carbonate monohydrate crystals into anhydrous sodium carbonate crystals; and lowering the temperature of the saturated sodium carbonate brine to below about 112° C. to convert anhydrous sodium carbonate crystals into sodium carbonate monohydrate crystals.

34. The process, as claimed in claim 27, wherein the step of separating sodium carbonate monohydrate crystals from insoluble impurities is by size separation.

35. The process, as claimed in claim 34, wherein the sodium carbonate monohydrate crystals separated from the insoluble impurities have a particle size of at least about 100 mesh.

36. The process, as claimed in claim 34, wherein a non-recovered portion from the step of size separating comprises insoluble impurities and sodium carbonate monohydrate crystals having a particle size of less than about 100 mesh.

37. The process, as claimed in claim 36, further comprising the step of dissolving sodium carbonate monohydrate crystals from the non-recovered portion and separating insoluble impurities from the dissolved crystals.

38. The process, as claimed in claim 37, further comprising the step of recycling the dissolved sodium carbonate monohydrate crystals from the non-recovered portion by introducing a stream containing the dissolved sodium carbonate monohydrate crystals into the saturated sodium carbonate brine solution.

39. The process, as claimed in claim 27, further comprising the step of calcining the separated sodium carbonate monohydrate crystals to anhydrous sodium carbonate crystals.

40. The process, as claimed in claim 27, wherein the amount of insoluble impurities in the separated sodium carbonate monohydrate crystals is less than about 0.2% by weight.

41. A process for the production of sodium carbonate monohydrate from trona ore, wherein the trona ore comprises trona and insoluble impurities, the process comprising:
(a) calcining the trona ore to produce a feed stream comprising anhydrous sodium carbonate and insoluble impurities;
(b) removing a size fraction comprising a less-than 10 micrometers size fraction from the feed stream to produce a modified feed stream;
(c) introducing the modified feed stream into a saturated sodium carbonate brine solution;
(d) classifying particles in the saturated sodium carbonate brine solution to remove insoluble impurities;
(e) converting the sodium carbonate monohydrate crystals in the slurry to anhydrous sodium carbonate crystals and then back to sodium carbonate monohydrate crystals;
(f) separating at least a portion of the sodium carbonate monohydrate crystals from at least a portion of the insoluble impurities.

42. The process, as claimed in claim 41, further comprising crushing the trona ore to minus 100 mesh prior to the calcination step.

43. The process, as claimed in claim 41, further comprising crushing the feed stream to minus 100 mesh prior to the step of removal of a size fraction.

44. The process, as claimed in claim 41, wherein the size fraction is a less-than 10 micrometers size fraction.

45. The process, as claimed in claim 41, wherein the step of removing is selected from the group consisting of screening, cycloning, air classification, or mechanical classification.

46. The process, as claimed in claim 41, wherein the step of removing removes at least about 90% by weight of the less-than 10 micrometers insoluble impurities to produce the modified feed stream.

47. The process, as claimed in claim 41, wherein the step of classifying removes at least about 90% by weight of the less-than 10 micrometers insoluble impurities introduced into the brine solution by the modified feed stream.

48. The process, as claimed in claim 41, wherein the step of classifying is selected from the group consisting of cyclone separation, elutriation, settling/thickening, and screening.

49. The process, as claimed in claim 41, wherein the step of classifying removes particles having a size less-than about 10 micrometers diameter.

50. The process, as claimed in claim 41, where in the step of converting comprises raising the temperature of the saturated sodium carbonate brine comprising the modified feed stream to above about 112° C. to convert sodium carbonate monohydrate crystals into anhydrous sodium carbonate crystals; and lowering the temperature of the saturated sodium carbonate brine to below about 112° C. to convert anhydrous sodium carbonate crystals into a second sodium carbonate monohydrate slurry.

51. The process, as claimed in claim 41, wherein the step of separating of sodium carbonate monohydrate crystals from insoluble impurities is by size separation.

52. The process, as claimed in claim 51, wherein sodium carbonate monohydrate crystals separated from insoluble impurities have a particle size of at least about 100 mesh.

53. The process, as claimed in claim 53, wherein a non-recovered portion from the step of size separating comprises insoluble impurities and sodium carbonate monohydrate crystals having a particle size of less than about 100 mesh.

55. The process, as claimed in claim 53, further comprising the step of dissolving sodium carbonate monohydrate crystals from the non-recovered portion and separating insoluble impurities from the dissolved crystals.

54. The process, as claimed in claim 53, further comprising the step of recycling the dissolved sodium carbonate monohydrate crystals from the non-recovered portion by introducing a stream containing the dissolved sodium carbonate monohydrate crystals into the saturated sodium carbonate brine solution.

56. The process, as claimed in claim 41, further comprising the step of calcining the separated sodium carbonate monohydrate crystals to anhydrous sodium carbonate crystals.

57. The process, as claimed in claim 41, wherein the amount of insoluble impurities in the separated sodium carbonate monohydrate crystals is less than about 0.2% by weight.

58. A process for the production of sodium carbonate monohydrate from trona ore, wherein the trona ore comprises trona and insoluble impurities, the process comprising:
(a) calcining the trona ore to produce a feed stream comprising anhydrous sodium carbonate and insoluble impurities;
(b) removing a size fraction comprising a minus 10 micrometers size fraction from the feed stream to produce a modified feed stream;
(c) introducing the modified feed stream into a saturated sodium carbonate brine solution to form a sodium carbonate monohydrate crystal slurry;
(d) converting the sodium carbonate monohydrate crystals in the slurry to anhydrous sodium carbonate crystals and then back to sodium carbonate monohydrate crystals,
(e) classifying particles in the second sodium carbonate monohydrate slurry to remove insoluble impurities;
(f) reconverting the sodium carbonate monohydrate crystals in the slurry to anhydrous sodium carbonate crystals and then back to sodium carbonate monohydrate crystals, and
(g) separating at least a portion of the sodium carbonate monohydrate crystals from at least a portion of the insoluble impurities in the saturated sodium carbonate brine solution.

59. The process, as claimed in claim 58, further comprising crushing the trona ore to minus 100 mesh prior to the calcination step.

60. The process, as claimed in claim 58, further comprising crushing the feed stream to minus 100 mesh prior to the step of removal of a size fraction.

61. The process, as claimed in claim 58, wherein the size fraction is a less-than 10 micrometers size fraction.

62. The process, as claimed in claim 58, wherein the step of removing is selected from the group consisting of screening, cycloning, air classification, or mechanical classification,

63. The process, as claimed in claim 58, wherein the step of removing removes at least about 90% by weight of the minus 10 micrometers insoluble impurities to produce the modified feed stream.

64. The process, as claimed in claim 58, where in the step of converting comprises raising the temperature of the saturated sodium carbonate brine comprising the modified feed stream to above about 112° C. to convert sodium carbonate monohydrate crystals into anhydrous sodium carbonate crystals; and lowering the temperature of the saturated sodium carbonate brine to below about 112° C. to convert anhydrous sodium carbonate crystals into a second sodium carbonate monohydrate slurry.

65. The process, as claimed in claim 58, wherein the step of classifying removes at least about 90% by weight of the less-than 10 micrometers insoluble impurities introduced into the brine solution by the modified feed stream.

66. The process, as claimed in claim 58, wherein the step of classifying is selected from the group consisting of cyclone separation, elutriation, settling/thickening, and screening.

67. The process, as claimed in claim 58, wherein the step of classifying removes particles having a size less than about 10 micrometers.

68. The process, as claimed in claim 58, where in the step of reconverting comprises raising the temperature of the second sodium carbonate monohydrate slurry to above about 112° C. to convert the sodium carbonate monohydrate crystals into anhydrous sodium carbonate crystals; and lowering the temperature of the saturated sodium carbonate brine to below about 112° C. to convert the anhydrous sodium carbonate crystals into sodium carbonate monohydrate crystals.

69. The process, as claimed in claim 58, wherein the step of separating sodium carbonate monohydrate crystals from insoluble impurities is by size separation.

70. The process, as claimed in claim 69, wherein sodium carbonate monohydrate crystals separated from the insoluble impurities have a particle size of at least about 100 mesh.

71. The process, as claimed in claim 69, wherein a non-recovered portion from the step of size separating comprises insoluble impurities and sodium carbonate monohydrate crystals having a particle size of less than about 100 mesh.

72. The process, as claimed in claim 71, further comprising the step of dissolving sodium carbonate monohydrate crystals from the non-recovered portion and separating the insoluble impurities from the dissolved crystals.

73. The process, as claimed in claim 72, further comprising the step of recycling the dissolved sodium carbonate monohydrate crystals from the non-recovered portion by introducing a stream containing the dissolved sodium carbonate monohydrate crystals into the saturated sodium carbonate brine solution.

74. The process, as claimed in claim 58, further comprising the step of calcining the separated sodium carbonate monohydrate crystals to anhydrous sodium carbonate crystals.

75. The process, as claimed in claim 58, wherein the amount of insoluble impurities in the separated sodium carbonate monohydrate crystals is less than about 0.2% by weight.

76. A process for the production of sodium carbonate monohydrate from trona ore, wherein the trona ore comprises trona and insoluble impurities, the process comprising:
(a) calcining the trona ore to produce a feed stream comprising anhydrous sodium carbonate and insoluble impurities;
(b) introducing the feed stream into a saturated sodium carbonate brine solution to form a sodium carbonate monohydrate crystal slurry;
(c) classifying particles in the sodium carbonate monohydrate slurry to remove insoluble impurities;
(d) converting the sodium carbonate monohydrate crystals in the slurry to anhydrous sodium carbonate crystals and then back to sodium carbonate monohydrate crystals;
(e) reclassifying particles in the second sodium carbonate monohydrate slurry to remove insoluble impurities;
(f) reconverting the sodium carbonate monohydrate crystals in the second sodium carbonate monohydrate slurry to anhydrous sodium carbonate crystals and then back to sodium carbonate monohydrate crystals; and
(g) separating at least a portion of the sodium carbonate monohydrate crystals from at least a portion of the insoluble impurities.

77. The process, as claimed in claim 76, further comprising crushing the trona ore to minus 100 mesh prior to the calcination step.

78. The process, as claimed in claim 76, further comprising crushing the feed stream to minus 100 mesh prior to the step of removal of a size fraction.

79. The process, as claimed in claim 76, wherein the step of classifying removes at least about 90% by weight of the less-than 10 micrometers insoluble impurities introduced into the brine solution by the feed stream.

80. The process, as claimed in claim 76, wherein the step of classifying is selected from the group consisting of cyclone separation, elutriation, settling/thickening, and screening.

81. The process, as claimed in claim 76, wherein the step of classifying removes particles having a size less than about 10 micrometers.

82. The process, as claimed in claim 76, where in the step of converting comprises raising the temperature of the first sodium carbonate monohydrate slurry to above about 112° C. to convert sodium carbonate monohydrate crystals into anhydrous sodium carbonate crystals; and lowering the temperature of the saturated sodium carbonate brine to below about 112° C. to convert anhydrous sodium carbonate crystals into a second sodium carbonate monohydrate crystal slurry.

83. The process, as claimed in claim 76, wherein the step of reclassifying removes at least about 90% by weight of the less-than 10 micrometers insoluble impurities entering the step of converting.

84. The process, as claimed in claim 76, wherein the step of reclassifying is selected from the group consisting of cyclone separation, elutriation, settling/thickening, and screening.

85. The process, as claimed in claim 76, wherein the step of reclassifying removes particles having a size less than about 10 micrometers.

86. The process, as claimed in claim 76, where in the step of reconverting comprises raising the temperature of the second sodium carbonate monohydrate slurry to above about 112° C. to convert the sodium carbonate monohydrate crystals into anhydrous sodium carbonate crystals; and lowering the temperature of the saturated sodium carbonate brine to below about 112° C. to convert the anhydrous sodium carbonate crystals into sodium carbonate monohydrate crystals.

87. The process, as claimed in claim 76, wherein the step of separating sodium carbonate monohydrate crystals from insoluble impurities is by size separation.

88. The process, as claimed in claim 87, wherein the sodium carbonate monohydrate crystals separated from the insoluble impurities have a particle size of at least about 100 mesh.

89. The process, as claimed in claim 87, wherein a non-recovered portion from the step of size separating comprises insoluble impurities and sodium carbonate monohydrate crystals having a particle size of less than about 100 mesh.

90. The process, as claimed in claim 89, further comprising the step of dissolving sodium carbonate monohydrate crystals from the non-recovered portion and separating insoluble impurities from the dissolved crystals.

91. The process, as claimed in claim 90, further comprising the step of recycling the dissolved sodium carbonate monohydrate crystals from the non-recovered portion by introducing a stream containing the dissolved sodium carbonate monohydrate crystals into the saturated sodium carbonate brine solution.

92. The process, as claimed in claim 76, further comprising the step of calcining the separated sodium carbonate monohydrate crystals to anhydrous sodium carbonate crystals.

93. The process, as claimed in claim 76, wherein the amount of insoluble impurities in the separated sodium carbonate monohydrate crystals is less than about 0.2% by weight.
